(19) United States
(12) Patent Application Publication
(10) Pub. No.: US 2007/0238413 A1
(43) Pub. Date: Oct. 11, 2007

(54) System and method for establishing an 802.11 network connection

(75) Inventor: Daryl David Coutts, Edmonton, CA (US)

Correspondence Address: Daryl D. Coutts, Suite 207, 11103 84 Ave, Edmonton, AB, T6G 2X4, CA

(73) Assignee: Knightsbridge Wireless Inc., Edmonton (CA)

(21) Appl. No.: 11/806,853

(22) Filed: Jun. 5, 2007

Related U.S. Application Data
(60) Provisional application No. 60/811,103, filed on Jun. 6, 2006.
(60) Provisional application No. 60/844,083, filed on Sep. 13, 2006.
(60) Provisional application No. 60/847,121, filed on Sep. 26, 2006.
(60) Provisional application No. 60/853,773, filed on Oct. 24, 2006.
(60) Provisional application No. 60/857,141, filed on Nov. 7, 2006.

(51) Int. Cl. H04B 7/00

(52) U.S. Cl. 455/41.2

(57) ABSTRACT

Methods and systems for facilitating the connection of computing devices to 802.11 networks are described.

### CROSS REFERENCE TO RELATED APPLICATIONS

This application claims the benefit of priority under 35 USC 119(e) to U.S. Provisional Application No. 60/811,103, filed Jun. 6, 2006, entitled “BLUETOOTH BEACON FOR A WIFI NETWORK”; U.S. Provisional Application No. 60/844,083, filed Sep. 13, 2006, entitled “ALTERNATIVE BEACON FOR A WIFI NETWORK”; U.S. Provisional Application No. 60/847,121, filed Sep. 26, 2006, entitled “SYSTEM AND METHOD FOR ESTABLISHING A WIFI NETWORK CONNECTION”; U.S. Provisional Application No. 60/853,773, filed Oct. 24, 2006, entitled “SYSTEM AND METHOD FOR ESTABLISHING AN 802.11 NETWORK CONNECTION”; and U.S. Provisional Application No. 60/857,141, filed Nov. 7, 2006, entitled “SYSTEMS AND METHOD FOR ESTABLISHING AN 802.11 NETWORK CONNECTION”, all of which are incorporated herein by reference in their entirety.

### TECHNICAL FIELD

This invention pertains to computerized methods and systems for facilitating the connection of computing devices to 802.11 networks.

### BACKGROUND OF THE INVENTION

802.11 enabled computing devices are becoming more prevalent. People want their computing devices to connect automatically to 802.11 networks. 802.11 is a large power consumer on computing devices, and it is a particularly large power consumer while it is searching for a network.

What is needed is a system and method such that computing devices connect rapidly when they come into range of a desired 802.11 network, that does not use too much power.

### BRIEF SUMMARY OF THE INVENTION

A Bluetooth device is placed near an access point of an 802.11 network. The Bluetooth device is configured such that its name corresponds to the Service Set Identifier (SSID) of the 802.11 network, whereby the Bluetooth device acts as a beacon for the 802.11 network.

This system utilizes the low power cost for device discovery in Bluetooth versus 802.11. Many computing devices now have both Bluetooth and 802.11 capability.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 illustrates an exemplary environment for establishing an 802.11 network connection by a computing device.

FIG. 2 is a block diagram of an exemplary computing device.

FIG. 3 illustrates a flowchart showing an exemplary process implemented on a Bluetooth device.

FIG. 3 illustrates a flowchart showing an exemplary process for establishing an 802.11 network connection by a computing device.

FIG. 4 illustrates a screen shot of an exemplary network list.

### DETAILED DESCRIPTION OF THE INVENTION

For the purpose of this document, 802.11 refers to any 802.11 protocol including 802.11a, 802.11b, 802.11g, 802.11n and 802.11p. An 802.11 network uses at least one of the 802.11 protocols.

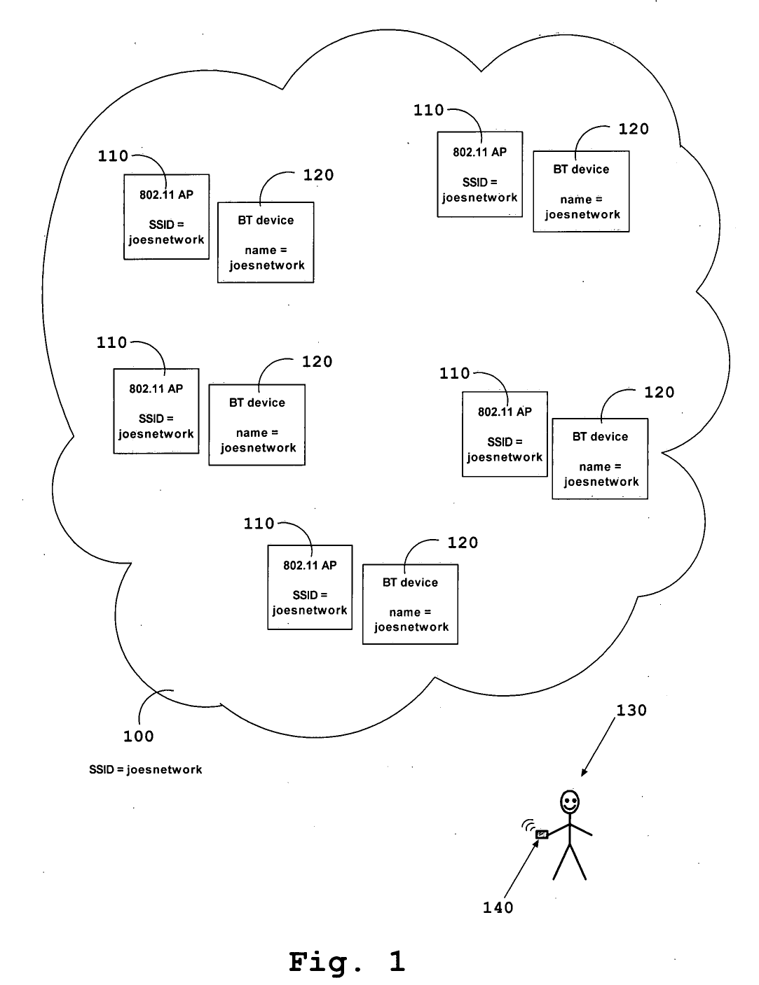

FIG. 1 illustrates an exemplary environment for establishing an 802.11 network connection. FIG. 1 shows an 802.11 network 100. The 802.11 network 100 in FIG. 1 has its SSID (802.11 Service Set Identifier) set to “joesnetwork”. The 802.11 network 100 is implemented using one or more access points. FIG. 1 shows five 802.11 access points 110 for the 802.11 network 100. Also shown in FIG. 1 are a plurality of Bluetooth devices 120. A Bluetooth device is a device that can transmit and receive information using the Bluetooth protocol. According to the Bluetooth specification, a name is associated with each Bluetooth device 120. The Bluetooth devices 120 may be configured such that their names are the same as the SSID for the 802.11 network 100, in this case “joesnetwork”, according to exemplary embodiments. The name of the Bluetooth device 120 does not have to match the SSID of the 802.11 network 100. There may be a correspondence between the name of the Bluetooth device 120 and the SSID of the 802.11 network 100. In fact, the name of the Bluetooth device 120 may be an encrypted version of the 802.11 network 100 SSID, according to some embodiments. FIG. 1 is an example only, the SSID of the 802.11 network 100 may comprise any name.

The Bluetooth devices 120 in FIG. 1 can be standalone devices or they may be modules that require external power and control signals. The Bluetooth devices 120 are located nearby the access points 110 of the 802.11 network 100. Nearby typically means within one hundred fifty metres. The Bluetooth devices 120 can also be located within the access points 110. There does not have to be one of the Bluetooth devices 120 for each of the access points 110. More than one of the Bluetooth devices 120 may correlate to more than one of the access points 110, and vice versa. Although FIG. 1 shows a plurality of the access points 110 and the Bluetooth devices 120, there might be as few as one of the access points 110 and one of the Bluetooth devices 120. There can also be an unlimited number of the access points 110 and the Bluetooth devices 120.

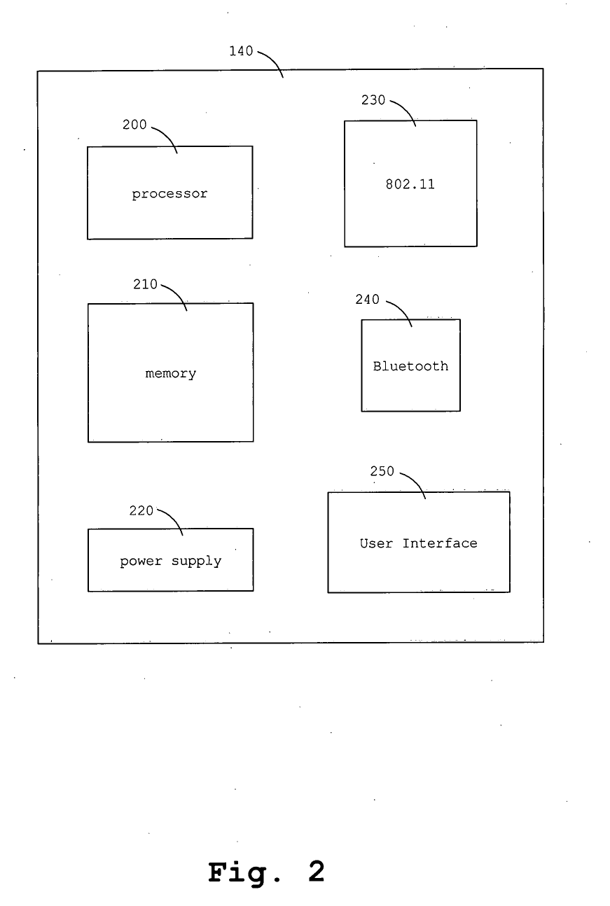

Also in FIG. 1, a user 130 is depicted with a computing device 140. The computing device 140 can be a PDA, handheld computer, cellphone or any other computing device. FIG. 2 shows a block diagram of an exemplary computing device, such as the computing device 140 shown in FIG. 1. The computing device 140 comprises functional blocks including a processor 200, memory 210, a power supply 220, an 802.11 module 230, a Bluetooth module 240, and a user interface 250.

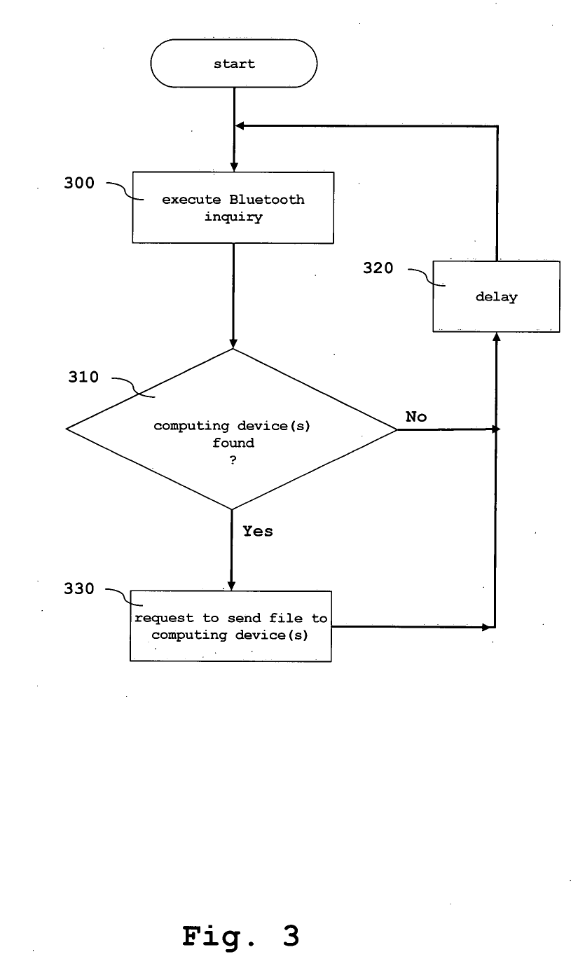

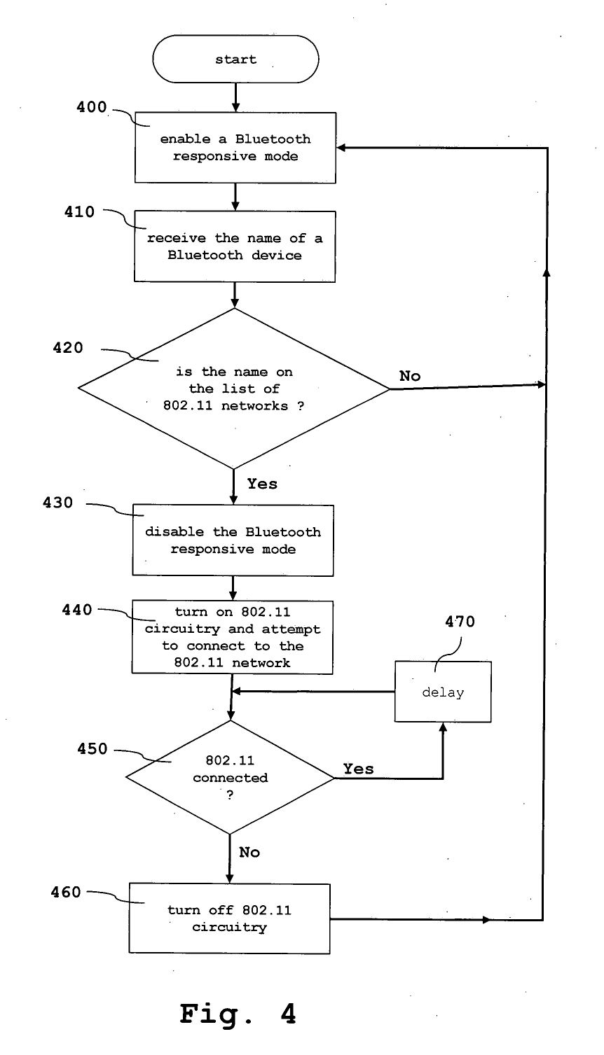

FIG. 3 illustrates a flowchart showing an exemplary process executed by the Bluetooth device 120. In step 300, the Bluetooth device 120 executes a Bluetooth inquiry as described in the Bluetooth specification. In an alternative embodiment, instead of executing the Bluetooth inquiry in step 300, a Bluetooth paging message may be transmitted.

Next, in step 310, it is determined if any computing devices, such as the computing device 140 illustrated in FIG. 1, have responded to the Bluetooth inquiry (or Bluetooth paging message). If no response is received, the process continues at step 320. Step 320 is a delay step, typically around one minute, but it could be a longer or shorter period of time, and the delay can vary. The purpose of the delay step 320 is to reduce interference between the Bluetooth device 120 and the 802.11 network 100. If the Bluetooth device 120 continuously executed Bluetooth inquiries, the performance of the 802.11 network 100 could be reduced notably. Of course if the delay in step 320 is made very long, computing devices 140, that come into range of the Bluetooth device 120, will take a very long time to connect to the 802.11 network 100.

If in step 310 it is determined that the computing device 140 has responded to the Bluetooth inquiry (or Bluetooth paging message) of step 300, the process continues at step 330. At step 330, the Bluetooth device 120 transmits a request to send a file to the computing device 140 discovered in steps 300 and 310. This file can be sent using OBEX (Object Exchange protocol) and the Bluetooth protocol. In an alternative embodiment, the file is not actually sent to the computing device 140. Rather, the act of transmitting the request to send the file to the computing device 140 sends the name of the Bluetooth device 120 to the computing device 140, which may be all the information needed by the computing device 140. Therefore the actual sending of the file may not be required. If the file is sent to the computing device 140, it may contain additional 802.11 network access information. In another alternative embodiment the name of the Bluetooth device 120 is transmitted to the computing device 140 as part of a request to send a vCard (electronic business card). Other ways to send the name of the Bluetooth device 120 to the computing device 140 using the Bluetooth protocol can be used at step 330.

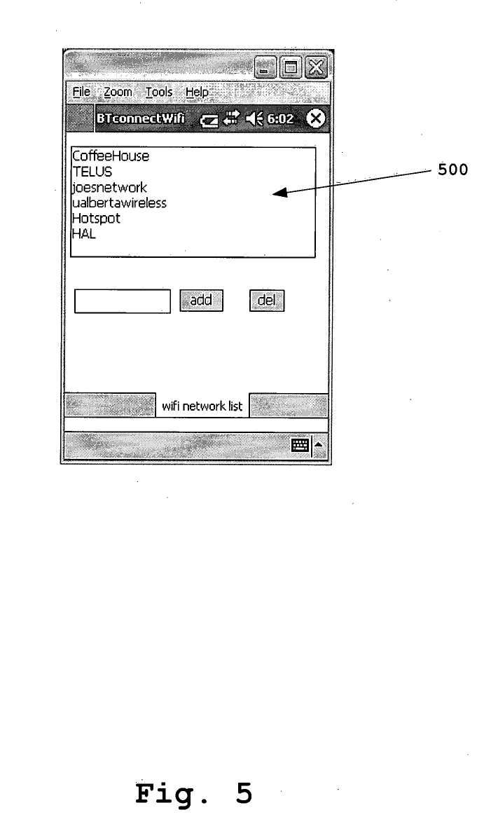

FIG. 4 illustrates an exemplary process executed by the computing device 140. In step 400, the computing device 140 is put into a Bluetooth responsive mode. A Bluetooth responsive mode is a mode whereby the computing device 140 will reply to transmissions received using the Bluetooth protocol. There are many different types of Bluetooth responsive modes some of which include inquiry scan and page scan.

In step 410 the name of the Bluetooth device 120 is received by the computing device 140. In one embodiment, step 410 is accomplished by receiving a file send request from the Bluetooth device 120, as discussed herein. The file send request is sent using OBEX and therefore contains the name of the sending device, which is the name of the Bluetooth device 120. At this point, the computing device 140 can choose to deny the file send request, because the computing device 140 has already learned the name of the Bluetooth device 120. The computing device 140 may also accept the file and, as discussed earlier, the file may contain additional 802.11 network access information.

In step 420, the name obtained in step 410 is checked against a list of 802.11 networks 500 (network lists 500 are discussed further in association with FIG. 5). If the name obtained in step 410 corresponds to an entry in the network list 500, the process continues at step 430. If there is no correspondence, the method continues at step 400.

In step 430, the computing device 140 is taken out of the Bluetooth responsive mode it was put into in step 400. The purpose of this step is to reduce the data traffic in the area around the 802.11 network 100.

Next, in step 440, the 802.11 circuitry 230 is turned on or set to an increased power state and an attempt is made to connect to the 802.11 network 100 identified in step 420. Attempting to connect to a network means performing an act that helps to establish a network connection. Examples of acts to help establish a network connection include increasing the power state of the 802.11 circuitry 230 on the computing device 140, transmitting an 802.11 association request, transmitting login credentials and enabling a network connection service on the computing device 140.

In step 450, it is determined if the computing device 140 is connected to an 802.11 network 100. If the computing device 140 is not connected to an 802.11 network 100, the process continues at step 460. If the computing device 140 is connected to an 802.11 network 100, then the process continues at 470. Step 470 is a delay step, typically around one minute, but it could be a longer or shorter period of time, and the delay can vary. The connection monitoring steps 450 and 470 can be done asynchronously. Some ways to determine if the computing device 140 is connected to an 802.11 network 100 include determining if the computing device 140 has a valid IP address and checking if the computing device 140 is able to receive data over the 802.11 network 100. Other ways to determine if a computing device 140 is connected to an 802.11 network 100 are possible.

Step 460 comprises reducing the power state of the 802.11 circuitry 230 on the computing device 140. After step 460, the process continues at step 400.

The flowcharts in FIG. 3 and FIG. 4 are examples only. Some steps may be eliminated, other steps can be added and some of the steps can be implemented asynchronously without departing from various embodiments.

FIG. 5 shows an exemplary network list 500. The network list 500 contains the SSIDs of the 802.11 networks 100 that the user 130 wants the computing device 140 to connect to automatically. Typically, the user 130 will edit the network list 500, but it is possible for the network list 500 to be produced in an automated manner. In this example, there are six SSIDs in the network list 500. In exemplary embodiments, the network list 500 comprises SSIDs of the 802.11 networks 100, but the network list 500 may comprise other information related to the 802.11 networks 100, such as addresses associated with the access points 110. The network list 500 is one example of an information set describing at least one wireless network. There are other possible ways to implement the information set describing at least one wireless network.

The network list 500 example in FIG. 5 has “joesnetwork” as an entry. If the computing device 140 in this example receives the name of the Bluetooth device 120 that is “joesnetwork”, the 802.11 circuitry on the computing device 140 is turned on and an attempt is made to connect to the 802.11 network 100 with SSID=“joesnetwork”. While various embodiments have been described above, it should be understood that it has been presented by way of example only, and not limitation. For example, an alternative embodiment could alter step 420 so that rather than comparing names of Bluetooth devices 120 to the network list 500, the Bluetooth addresses of the Bluetooth devices 120 could be compared to a database of Bluetooth addresses. Many alternative embodiments are possible.

I claim:

1. A system for facilitating the connection of a computing device to an 802.11 network comprising:
a Bluetooth device configured such that its name corresponds to the SSID of the 802.11 network; and
the Bluetooth device placed nearby an access point of the 802.11 network.

2. The system of claim 1 where the Bluetooth device executes a Bluetooth inquiry.

3. The system of claim 1 where the Bluetooth device transmits a request to send data.

4. The system of claim 3 where the data is one selected from the list of: a file, a vcard and a electronic business card.

5. A method for establishing a connection to an 802.11 network, the method implemented on a computing device, the computing device having a stored information set describing at least one 802.11 network, the method comprising: receiving a first information corresponding to the name of a Bluetooth device; and if the first information also corresponds to information in the stored information set, attempting to connect to the 802.11 network.

6. The method of claim 5 where attempting to connect to the 802.11 network comprises increasing the power state of 802.11 circuitry on the computing device.

7. The method of claim 5 where attempting to connect to the 802.11 network comprises transmitting an 802.11 association request.

8. The method of claim 5 where attempting to connect to the 802.11 network comprises enabling a network connection service on the computing device.

9. The method of claim 5 further comprising executing a Bluetooth inquiry.

10. A method for establishing a connection to an 802.11 network, the method implemented on a computing device, the computing device having a stored information set describing at least one 802.11 network, the method comprising:
enabling a first Bluetooth responsive mode on the computing device;
receiving a first information;
if the first information corresponds to information in the stored information set, attempting to connect to the 802.11 network; and
disabling the first Bluetooth responsive mode.

11. The method of claim 10 where the first information is received using the Bluetooth protocol.

12. The method of claim 10 where the first Bluetooth responsive mode is one of Bluetooth inquiry scan and Bluetooth page scan.
